(19) United States
(12) Patent Application Publication
(10) Pub. No.: US 2022/0311149 A1
(43) Pub. Date: Sep. 29, 2022

(54) TERMINAL MODULE

(71) Applicant: SUMITOMO WIRING SYSTEMS, LTD., Mie (JP)

(72) Inventors: Keisuke KANEMURA, Mie (JP); Ai HIRANO, Mie (JP)

(21) Appl. No.: 17/698,746

(22) Filed: Mar. 18, 2022

(30) Foreign Application Priority Data
Mar. 26, 2021 (JP) 2021-053316

(51) Int. Cl. H01R 4/18; H01B 7/28; H01R 13/6592

(52) U.S. Cl. CPC H01R 4/183; H01B 7/28; H01R 13/6592

(57) ABSTRACT

A terminal module includes a cable, inner conductor terminals, and a positioning member. The cable includes a core, a shield member and a sheath. The core includes a core body portion to be arranged on an inner peripheral side of the sheath and a core extending portion extending from the core body portion and to be arranged closer to a tip of the cable than a tip of the sheath. The shield member includes a shield member body portion to be arranged on an outer peripheral side of the core body portion and arranged on an inner peripheral side of the sheath and a shield member extending portion extending from a tip of the shield member body portion and to be arranged on an outer peripheral side of the core extending portion.

### CROSS-REFERENCE TO RELATED APPLICATIONS

This application is based on and claims priority from Japanese Patent Application No. 2021-053316, filed on Mar. 26, 2021, with the Japan Patent Office, the disclosure of which is incorporated herein in its entirety by reference.

### TECHNICAL FIELD

The present disclosure relates to a terminal module.

### BACKGROUND

Japanese Patent Laid-open Publication No. 2018-504755 discloses a terminal module in which a plug connector is connected to a cable. The cable includes an inner conductor and an outer conductor surrounding the inner conductor. A tip part of the inner conductor is electrically connected to an inner conductor contact point of the plug connector without being covered by the outer conductor. A sleeve part is arranged outside the tip part of the inner conductor not covered by the outer conductor to adjust an impedance. Note that a terminal module is also disclosed in International Publication No. WO 2008/146645 and Japanese Patent Laid-open Publication Nos. 2009-054357, 2010-182631, 2011-124136, 2014-017100, 2018-092801, 2019-106278 and 2021-015701.

### SUMMARY

Since the sleeve part is arranged on a tip side of the outer conductor in the configuration of Japanese Patent Laid-open Publication No. 2018-504755, a clearance is formed between the outer conductor and the sleeve part, which may lead to reduced shielding performance.

Accordingly, the present disclosure aims to provide a technique capable of improving the shielding performance of a terminal module.

The present disclosure is directed to a terminal module with a cable, an inner conductor terminal to be connected to a tip part of the cable, and a positioning member to be arranged on an outer peripheral side of the cable, wherein the cable includes a core, a shield member and a sheath, the core includes a core body portion to be arranged on an inner peripheral side of the sheath and a core extending portion extending from the core body portion and to be arranged closer to a tip of the cable than a tip of the sheath, the shield member includes a shield member body portion to be arranged on an outer peripheral side of the core body portion and arranged on an inner peripheral side of the sheath and a shield member extending portion extending from a tip of the shield member body portion and to be arranged on an outer peripheral side of the core extending portion, and the positioning member includes a fixing portion to be fixed to an outer peripheral side of the sheath and a positioning portion to be brought into contact with an outer peripheral side of the shield member extending portion.

According to the present disclosure, it is possible to improve the shielding performance of a terminal module.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a terminal module of one embodiment.

FIG. 2 is a plan view in section of the terminal module of the embodiment.

FIG. 3 is a plan view in section of the terminal module of the embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure are listed and described.

(1) The terminal module of the present disclosure includes a cable, an inner conductor terminal to be connected to a tip part of the cable, and a positioning member to be arranged on an outer peripheral side of the cable, wherein the cable includes a core, a shield member and a sheath, the core includes a core body portion to be arranged on an inner peripheral side of the sheath and a core extending portion extending from the core body portion and to be arranged closer to a tip of the cable than a tip of the sheath, the shield member includes a shield member body portion to be arranged on an outer peripheral side of the core body portion and arranged on an inner peripheral side of the sheath and a shield member extending portion extending from a tip of the shield member body portion and to be arranged on an outer peripheral side of the core extending portion, and the positioning member includes a fixing portion to be fixed to an outer peripheral side of the sheath and a positioning portion to be brought into contact with an outer peripheral side of the shield member extending portion.

In this terminal module, the shield member includes the shield member extending portion extending from the tip of the shield member body portion and to be arranged on the outer peripheral side of the core extending portion. Thus, according to this terminal module, the core body portion and the core extending portion can be continuously shielded. Moreover, the spread of the shield member extending portion toward the outer peripheral side can be suppressed by bringing the positioning portion into contact with the outer peripheral side of the shield member extending portion. As a result, an impedance of the core extending portion can be adjusted.

(2) Preferably, the terminal module includes an outer conductor terminal to be arranged on outer peripheral sides of the inner conductor terminal and the positioning member, the shield member includes a folded portion continuous with a tip of the shield member extending portion and folded via the positioning portion and a shield member outer peripheral portion extending from the folded portion and to be arranged on an outer peripheral side of the fixing portion, and the outer conductor terminal includes a crimping portion for sandwiching the shield member outer peripheral portion between the fixing portion of the positioning member and the crimping portion.

According to this configuration, the shield member folded on the tip side of the positioning portion can be sandwiched and held between the crimping portion of the outer conductor terminal and the fixing portion of the positioning member. Thus, the tip of the shield member can be positioned by the positioning portion. Further, the positioning member can have both a function of adjusting an impedance and a function of holding the outer conductor terminal.

### Details of Embodiment of Present Disclosure

A specific example of the present disclosure is described below with reference to the drawings. Note that the present disclosure is not limited to these illustrations and is intended to be represented by claims and include all changes in the scope of claims and in the meaning and scope of equivalents.

### <Embodiment>

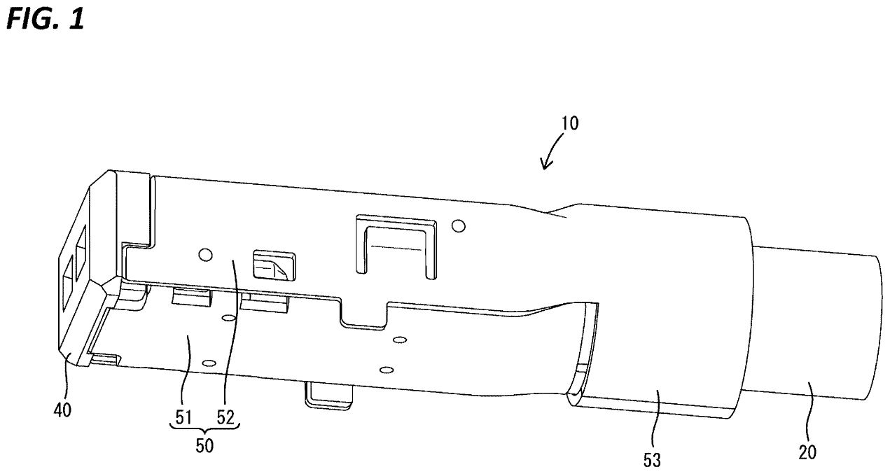

FIG. 1 shows a terminal module 10 of one embodiment. The terminal module 10 is connected to an unillustrated mating terminal.

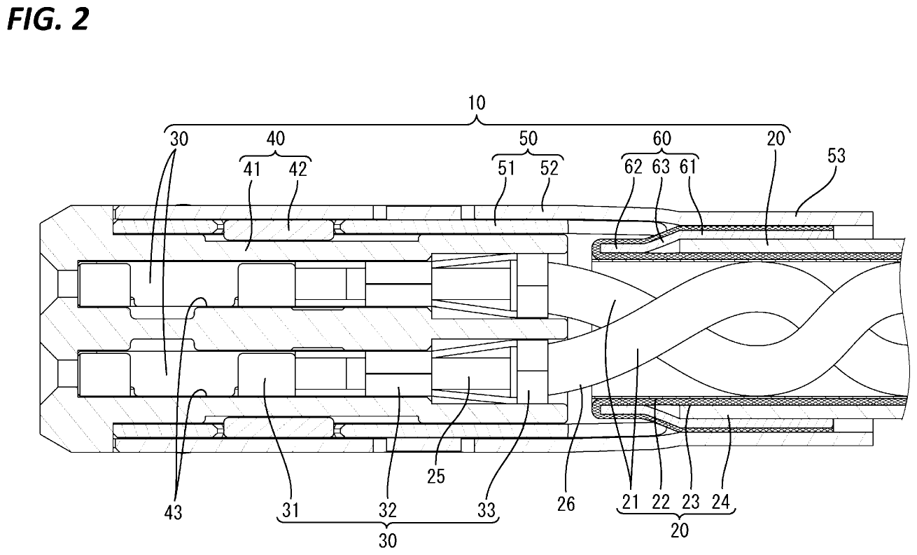

As shown in FIG. 2, the terminal module 10 includes a cable 20, inner conductor terminals 30, a dielectric 40, an outer conductor terminal 50 and a positioning member 60.

The cable 20 is, for example, a STP (Shielded Twisted Pair) cable. As shown in FIG. 2, the cable 20 includes cores 21, a copper pet 22, a shield member 23 and a sheath 24.

As shown in FIG. 2, the core 21 includes a conductive conductor 25 and an insulating coating 26. A tip part of the conductor 25 is exposed without being covered by the coating 26 and crimped to the inner conductor terminal 30. The coating 26 is arranged on an outer peripheral side of the conductor 25 except at the tip part of the conductor 25. Note that, in this embodiment, the outer peripheral side is a radially outer side of the cable 20, and an inner peripheral side is a radially inner side of the cable 20.

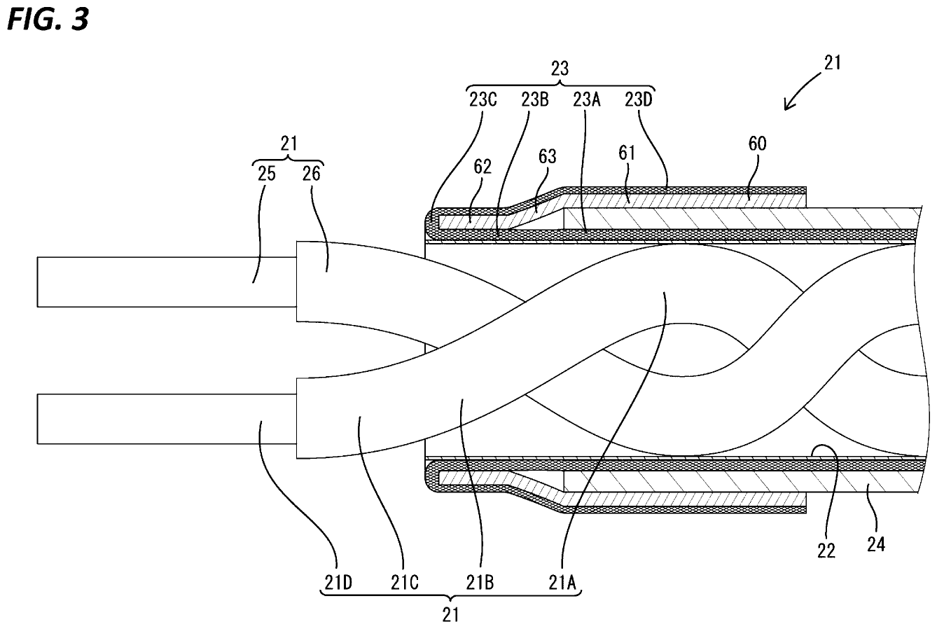

As shown in FIG. 3, a pair of the cores 21 are provided and configured as a twisted wire. The core 21 includes a core body portion 21A, a core extending portion 21B, a second extending portion 21C and a core tip portion 21D. The core body portion 21A is arranged on an inner peripheral side of the sheath 24. The core extending portion 21B, the second extending portion 21C and the core tip portion 21D are arranged closer to the tip of the cable than the tip of the sheath 24. The core extending portion 21B extends from the tip of the core body portion 21A. The second extending portion 21C extends from the tip of the core extending portion 21B. The core tip portion 21D extends from the tip of the second extending portion 21C. The outer periphery of the conductor 25 in the core body portion 21A, the core extending portion 21B and the second extending portion 21C is covered by the coating 26. The conductor 25 is exposed from the core tip portion 21D and crimped to the inner conductor terminal 30.

The copper pet 22 is configured by laminating a pet film on a copper foil and has a shielding property. As shown in FIG. 2, the copper pet 22 is arranged on an outer peripheral side of the core body portions 21A and arranged on inner peripheral sides of the shield member 23 and the sheath 24.

The shield member 23 has a conductive property and, for example, a braided wire. The shield member 23 has a tubular shape, specifically a hollow cylindrical shape. As shown in FIG. 3, the shield member 23 includes a shield member body portion 23A, a shield member extending portion 23B, a folded portion 23C and a shield member outer peripheral portion 23D. The shield member body portion 23A is arranged on an outer peripheral side of the core body portions 21A. The shield member extending portion 23B extends from the tip of the shield member body portion 23A and is arranged on an outer peripheral side of the core extending portions 21B. The folded portion 23C is continuous with the tip of the shield member extending portion 23B. The shield member outer peripheral portion 23D is folded toward the outer peripheral side in the folded portion 23C and extends toward a side opposite to the tip side of the cable 20.

The sheath 24 has an insulating property. The sheath 24 has a tubular shape, specifically a hollow cylindrical shape.

The positioning member 60 has a conductive property and is formed, for example, by bending a metal plate. As shown in FIG. 3, the positioning member 60 includes a fixing portion 61, a positioning portion 62 and a coupling portion 63. The fixing portion 61 is in the form of an open barrel and formed into a tubular shape. The fixing portion 61 is fixed to the outer periphery of the sheath 24 by crimping. The positioning portion 62 is arranged closer to the tip side of the cable 20 than the fixing portion 61. The positioning portion 62 is also in the form of an open barrel and formed into a tubular shape. The positioning portion 62 has a smaller diameter than the fixing portion 61. The positioning portion 62 is arranged on outer peripheral sides of the core extending portions 21B and the shield member extending portion 23B. The positioning portion 62 is arranged in contact with the outer peripheral side of the shield member extending portion 23B. The coupling portion 63 has a curved cross-sectional shape cut by a virtual plane orthogonal to an extending direction of the cable 20, and becomes narrower from the side of the fixing portion 61 toward the side of the positioning portion 62.

The inner conductor terminal 30 has a conductive property and is formed, for example, by bending a metal plate. As shown in FIG. 2, the inner conductor terminal 31 includes an inner conductor body portion 31, a wire barrel 32 and an insulation barrel 33. The inner conductor body portion 31 has a tubular shape and is connected to an unillustrated mating terminal. The wire barrel 32 is in the form of an open barrel, and crimped to the conductor 25 of the core 21. The insulation barrel 33 is in the form of an open barrel and crimped to the coating 26 of the core 21. A pair of the inner conductor terminals 30 are provided and respectively crimped to the cores 21.

The dielectric 40 is made of synthetic resin and has an insulating property. As shown in FIG. 2, the dielectric 40 is interposed between the inner conductor terminals 30 and the outer conductor terminal 50. The dielectric 40 includes a first dielectric portion 41 and a second dielectric portion 42 to be coupled to each other. The dielectric 40 includes a terminal accommodating portion 43 for accommodating the inner conductor terminals 30. Although not shown, the terminal accommodating portion 43 is formed by being surrounded by the first and second dielectric portions 41, 42.

The outer conductor terminal 50 has a conductive property. As shown in FIGS. 1 and 2, the outer conductor terminal 50 includes a first outer conductor portion 51 and a second outer conductor portion 52 which form a tubular shape by being coupled to each other. The outer conductor terminal 50 is arranged on outer peripheral sides of the inner conductor terminals 30 and the positioning member 60. The second outer conductor portion 52 of the outer conductor terminal 50 includes a crimping portion 53. The crimping portion 53 is in the form of an open barrel and crimped with the shield member outer peripheral portion 23D sandwiched between the positioning member 60 and the fixing portion 61 and the crimping portion 53.

The terminal module 10 is manufactured as follows. In the cable 20, the tip side of the sheath 24 is first removed and the exposed shield member 23 is folded on the outer peripheral side of the sheath 24. Then, tip sides of the cores 21 are untwisted, and tip parts of the coatings 26 of the cores 21 are removed. The folded part of the shield member 23 is moved toward an initial position, and the fixing portion 61 of the positioning member 60 is crimped to the outer periphery of the sheath 24. Then, the positioning portion 62 of the positioning member 60 is deformed into a tubular shape and the shield member 23 is folded on the tip of the positioning member 60.

The inner conductor terminal 30 is crimped to each of the cores 21. The inner conductor terminals 30 are accommodated in the terminal accommodating portion 43 of the dielectric 40. The first and second outer conductor portions 51, 52 are coupled to each other and arranged to cover the outer peripheries of the inner conductor terminals 30. The crimping portion 53 of the second outer conductor portion 52 is crimped with the shield member outer peripheral portion 23D sandwiched between the fixing portion 61 of the positioning member 60 and the crimping portion 53. The crimping portion 53 is formed to have a circular cross-section.

As describe above, in the terminal module 10, the shield member 23 includes the shield member extending portion 23B extending from the tip of the shield member body portion 23A and to be arranged on the outer peripheral side of the core extending portions 21B. Thus, according to this terminal module 10, the core body portion 21A and the core extending portion 21B can be continuously shielded. Moreover, the spread of the shield member extending portion 23B toward the outer peripheral side can be suppressed by bringing the positioning portion 62 into contact with the outer peripheral side of the shield member extending portion 23B. As a result, an impedance of the core extending portion 21B can be adjusted.

Further, the shield member 23 includes the folded portion 23C continuous with the tip of the shield member extending portion 23B and folded via the positioning portion 62 and the shield member outer peripheral portion 23D extending from the folded portion 23C and to be arranged on the outer peripheral side of the fixing portion 61. The outer conductor terminal 50 includes the crimping portion 53 for sandwiching the shield member outer peripheral portion 23D between the fixing portion 61 of the positioning member 60 and the crimping portion 53. According to this configuration, the shield member 23 folded on the tip side of the positioning portion 62 can be sandwiched and held between the crimping portion 53 of the outer conductor terminal 50 and the fixing portion 61 of the positioning member 60. Therefore, the tip of the shield member 23 is positioned by the positioning portion 62. Further, the positioning member 60 can have both a function of adjusting an impedance and a function of holding the outer conductor terminal 50.

### [Other Embodiment of Present Disclosure]

The embodiment disclosed this time should be considered illustrative in all aspects, rather than restrictive.

(1) Although the positioning member of the above embodiment includes the coupling portion, the positioning member may not include the coupling portion. For example, the fixing portion and the positioning portion may be directly coupled.

(2) Although the coupling portion of the positioning member of the above embodiment is inclined, the coupling portion may not be inclined. For example, the coupling portion may extend in a radial direction of the fixing portion.

(3) Although the core of the above embodiment includes the second extending portion, the core may not include the second extending portion. That is, the core tip portion may extend from the tip of the core extending portion.

(4) Although the cable of the above embodiment includes the copper pet, the cable may not include the copper pet. Further, the cable may include a member formed by laminating a pet film on another metal foil, such as an aluminum pet, instead of the copper pet.

(5) Although the fixing portion of the above embodiment is fixed by being directly crimped to the cable, the fixing portion may be fixed by another method. For example, the fixing portion may be indirectly fixed to the cable by receiving a crimping force of the crimping portion of the outer conductor terminal.

(6) Although the fixing portion and the positioning portion of the above embodiment are in the form of open barrels, the fixing portion and the positioning portion may be in other shapes. For example, these may be in the form of sleeves.

Further, one of the fixing portion and the positioning portion may be in the form of an open barrel and the other may be in the form of a sleeve.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A terminal module, comprising:
a cable;
an inner conductor terminal to be connected to a tip part of the cable; and
a positioning member to be arranged on an outer peripheral side of the cable, wherein:
the cable includes a core, a shield member and a sheath,
the core includes a core body portion to be arranged on an inner peripheral side of the sheath and a core extending portion extending from the core body portion and to be arranged closer to a tip of the cable than a tip of the sheath,
the shield member includes a shield member body portion to be arranged on an outer peripheral side of the core body portion and arranged on an inner peripheral side of the sheath and a shield member extending portion extending from a tip of the shield member body portion and to be arranged on an outer peripheral side of the core extending portion, and
the positioning member includes a fixing portion to be fixed to an outer peripheral side of the sheath and a positioning portion to be brought into contact with an outer peripheral side of the shield member extending portion.

2. The terminal module of claim 1, comprising an outer conductor terminal to be arranged on outer peripheral sides of the inner conductor terminal and the positioning member, wherein:
the shield member includes a folded portion continuous with a tip of the shield member extending portion and folded via the positioning portion and a shield member outer peripheral portion extending from the folded portion and to be arranged on an outer peripheral side of the fixing portion, and
the outer conductor terminal includes a crimping portion for sandwiching the shield member outer peripheral portion between the fixing portion of the positioning member and the crimping portion.
